(19) United States
(12) Patent Application Publication
(10) Pub. No.: US 2011/0031398 A1
(43) Pub. Date: Feb. 10, 2011

(54) Imaging Apparatus and Method

(76) Inventors: Martin F. Finlan, Doncaster South Yorkshire (GB); Shelley J. Wilkins, Doncaster South Yorkshire (GB)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/937,279

(22) PCT Filed: Apr. 9, 2009
(86) PCT No.: PCT/GB09/50357

§ 371 Date: Oct. 11, 2010

(30) Foreign Application Priority Data
Apr. 11, 2008 (GB) 0806673.0

(51) Int. Cl. G01N 23/00

(52) U.S. Cl. 250/307; 250/310

(57) ABSTRACT

The imaging apparatus comprises a micro-pipette (11) having a first electrode (12) within it and a second electrode (13) close to but outside of the micro-pipette (11). As the tip of the micro-pipette is brought close to a sample (14) variation of the current flowing between the two electrodes is representative of the distance separating the tip of the micro-pipette and the sample surface and monitoring variations in the current flow enables the topography of the sample surface to be imaged. To establish current flow between the two electrodes, an ionising source such as a UV lamp is used to ionise the environment in which the electrodes are located. The imaging apparatus enables scanning ion conductance microscopy to be performed without the need for the sample to be immersed in an electrolyte solution.

### FIELD OF THE INVENTION

This invention relates to scanning probe microscopy, and in particular relates to imaging at high resolution using micro- or nano-pipettes.

### BACKGROUND TO THE INVENTION

Technologies for imaging surfaces at molecular and atomic scales are of increasing importance for a wide range of applications. Imaging surfaces for topographical features is currently achieved using a number of different approaches.

Optical microscopy (using visible light) has been applied widely. However, in some areas of technology optical instruments can have a limited life span, particularly where high levels of ionising radiation exist. In the presence of ionising radiation, transparent optical components such as lenses darken rapidly and become useless until annealed. Also electronic components have a limited lifetime in these conditions, even when radiation hardened.

The resolution achievable with optical microscopy is limited by diffraction to about 200-250 nm. For more detailed study, one commonly used method is electron microscopy, including both scanning electron microscopy (SEM) and transmissions electron microscopy (TEM), where it is possible to obtain images with 10 nm resolution or better. However, electron microscopy involves a number of limitations in the sample preparation including the need for the sample to be fixed and metallised prior to imaging and the need for the sample to be present in a high vacuum during imaging. Hence, electron microscopy is unsuitable for some applications, e.g. the imaging of living cells.

Another high resolution technique capable of atomic or near atomic resolution imaging that is often applied is Scanning Probe Microscopy (SPM) where a sharp tip is raster scanned across a surface, e.g. atomic force microscopy (AFM) and scanning tunnelling microscopy (STM). The consequent tip-sample interactions and thus the chemical/physical properties of the sample can be plotted as a function of the tip's position with respect to the sample, to generate a profile of this measured interaction.

Tip-sample interaction in some cases may lead to damage of the surface as the sharp tip is scanned over the surface and can be very problematic when imaging fragile or soft surfaces, for example, biological materials and polymers. Scanning ion conductance microscopy (SICM) is another member of the SPM family that is used for imaging soft surfaces.

As shown in FIG. 1, a general SICM arrangement includes a glass micro-, or nano-, pipette 1 filled with electrolyte 2 which is scanned over the surface of a sample 3 bathed in an electrolytic solution 4; see Hansma et al (1989) Science 243:641-3. The pipette 1 contains a solution of ions and is reciprocated orthogonally to the sample surface by a driver 5. An ion-current in the pA range flows, via the pipette aperture 6, between two electrodes 7,8: one inside the pipette and another outside in the electrolyte solution 4. Change in current flow from within the pipette 1 to the surrounding solution 4 when it is close to the surface is used to position the tip at a constant distance from the surface while the pipette is raster scanned across it, driven by the driver 5. By modulating the distance of the pipette from the surface, a more robust and reliable method for scanning can be applied for continuous scanning over long periods (Korchev et al 2000) where the probe never makes physical contact with the surface.

The optimum tip-sample separation that has allowed SICM to be established as a non-contact profiling method for elaborated surfaces is approximately one-half of the tip diameter; see Korchev et al (1997), J. Microsc. 188:17-23, and also Biophys. J. 73:653-8. The outputs of the system controlling the position of the tip are used to generate images of topographic features on the sample surface. The spatial resolution achievable using SICM is dependent on the size of the tip aperture, and is typically between 50 nm and 1.5 μm. This produces a corresponding image resolution.

U.S. Pat. No. 4,924,091 (Hansma et al) describes a SICM arrangement in which the sample is bathed in an electrolyte solution and multiple micro-pipette probes are used each having a respective ion specific electrode. This SICM arrangement enables simultaneous scanning of the sample surface based on multiple ion currents.

The principle use of SICM has been to image live cells, where the ability to create near molecular scale images without damaging the cells has been invaluable. One of the limitations of SICM in its application to materials and physical sciences is that there must be an electrolyte solution surrounding the scanned surface for ion flow and in order for feedback to be maintained to prevent the probe from colliding with the surface. In the case of nano-engineering, micro-electro mechanical systems (MEMS), nano-electro mechanical systems (NEMS) and semi-conductors etc., immersing samples in electrolyte is often not a viable option for analysis.

There is therefore a need in the art for a technique for high resolution imaging of samples in the absence of electrolyte solution without any physical contact with the sample surface.

### SUMMARY OF THE INVENTION

According to a first aspect of this invention, there is provided a scanning probe microscope for interrogating a surface, comprising a first electrode located within the scanning probe; a second electrode located adjacent the probe and the surface; and means for ionising the environment in the vicinity of the electrodes such that an ion current flows upon application of a potential difference across the electrodes.

According to a second aspect of this invention, there is provided a method for interrogating a surface using a scanning probe microscope having a first electrode located within the scanning probe and a second electrode located adjacent the probe and the surface, the method comprising moving the scanning probe into close proximity with the surface; ionising the environment in the vicinity of the electrodes, and applying a potential difference across the electrodes to generate an ion current flow in the ionised environment between the first and second electrodes.

The scanning probe may be a hollow nano-pipette similar to that used for SICM, although not electrolyte-filled. One electrode is placed inside the nano-pipette and another electrode is placed adjacent the pipette and substrate surface. By generating ionisation of the environment around the electrodes, rather than providing an electrolyte solution in which the sample is immersed, the present invention has applications to areas such as, but not limited to, semi-conductors, MEMS, NEMS, micro-fluidics and micro-engineering and electronics.

Reference herein to ionising the environment is intended as reference to any environment in which the formation of ions is induced for example by means of irradiation. Reference to ionising the environment is not intended to encompass and does not include environments in which ions naturally exist, e.g. by solvation, such as in an electrolyte. Generally, the environment is non-aqueous and prior to ionisation is non-ionised.

Ionisation of the environment may be achieved in a variety of ways. For example, ions may be generated by the radiation from a UV lamp, from a suitable alpha or beta emitting source, or from the sample itself which may be sufficiently radioactive. Alternatively, ionisation of the environment may be achieved at low pressures with an appropriate electrode potential.

The apparatus and method in accordance with this invention can be operated in environments including vacuums, gases and insulating fluids.

The pipette may be controlled to scan across the sample surface in a similar manner as for SICM, and topographical images of the surface may be similarly generated.

### BRIEF DESCRIPTION OF THE DRAWINGS

Preferred examples of the present invention will now be described with reference to the accompanying drawings, in which:

FIG. 1 shows a convention SICM setup;

FIG. 2 shows a scanning probe microscope setup in accordance with this invention with an ion source;

FIG. 3 shows a scanning probe microscope setup in accordance with this invention without an ion source; and

FIG. 4 shows exemplary electrode impedance characteristics for the setup of FIG. 3.

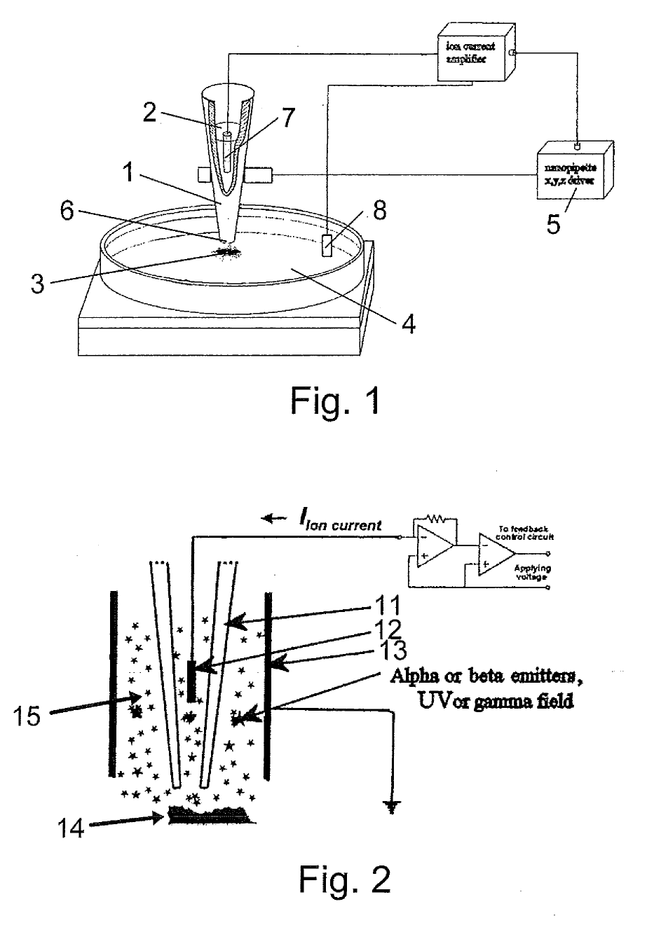

### DETAILED DESCRIPTION

In the arrangement shown in FIG. 2, an example of the scanning probe microscope is illustrated which includes a hollow nano-pipette 11 having an internal electrode 12, which can be any suitable conductor, or can be plated onto the inside of the pipette 11. An external electrode 13 is shown in the form of a cylinder surrounding the pipette tip, but could be mounted as several strips. The use of several strips, insulated from each other, would facilitate the measurement of azimuthal current variation. The pipette 11 is positioned in close proximity to a sample 14, for example at around a separation equal to half the diameter of the tip of the nano-pipette 11. A driver (not shown) similar to that used in conventional SICM may be used to control the pipette tip position relative to the sample in x, y and z directions.

When not in use a non-ionised environment exists around the electrodes 12, 13 and the sample. In particular, around the electrodes 12, 13 the environment is a non-ionised gas or other fluid but excluding electrolyte fluids and other fluids in which ionised species naturally exist. During use, ionisation of the environment 15 is induced around the electrodes 12,13 such that an ion-current flows between the two electrodes upon application of a potential difference across the electrodes. As the pipette tip is brought closer to the sample surface, the ion-current will be reduced and variation in the ion-current flow between the electrodes is monitored by means of a current detector (not shown). This effect is used to maintain the pipette tip at a fixed distance from the surface of the sample during a raster scan. Adjustments in the height of the pipette tip to maintain a fixed tip-surface separation are then translated into a topographical map of the sample surface. If the tip is oscillated axially at frequencies in the region, but not limited to, near zero to 4 kHz or more, the oscillation frequency of the ion stream can be detected using a lock-in amplifier to better control the tip-surface separation.

The scanning probe microscope may also be operated in “hopping mode” to sample the surface to be scanned to ascertain which areas are of most relevance to the investigator. The pipette is cycled in height above the surface with an amplitude which is greater than the maximum hill valley distance at discrete points across the surface. No lateral movement of the pipette close to the sample surface which could damage the surface or tip takes place at these points. A preferred embodiment would do this at four points for a square sample, and would then repeat the process at a number of points within the square determined by an analysis of the height measurements, indicating surface roughness, from the initial four points. This analysis would be ongoing for subsequent points to provide for a final SICM scan only over the region with structures of interest, and within that region to produce an image whose resolution is adapted locally to the surface complexity.

As for SICM, the ion currents between the electrodes are in the pA region, and the oscillation of the tip to generate an alternating current signal to the current detector gives an improved signal to noise ratio needed to control the tip height effectively.

Ionisation of the environment around the electrodes may be caused in a variety of ways. For example, a UV lamp emitting radiation at 200 nm or below can be used to create an ionised gas environment around the electrodes. In this case, the nano-pipette 11 is preferably made of silica, or a similar substance which is transparent to these EM radiation frequencies. Ions may also be generated using a suitable source of ionising radiation, e.g. alpha or beta emitting sources.

This arrangement is comparable with smoke detector assemblies where, as an example, the ion current flow where the source of ions is 0.4 μCi (14.8 kBq) of an alpha emitting sealed source of Americium-241, is in the region of 10 nA to 1 pA, and the mobilities of the ions exceeds that of those in solution by a substantial margin.

A source of ionising radiation external to the microscopy arrangement, such as described above, is not required where the sample being studied is itself sufficiently radioactive. Radiation from a radioactive source would readily generate the ion density around the electrodes needed for this microscopy arrangement to work in air, or any appropriate fluid.

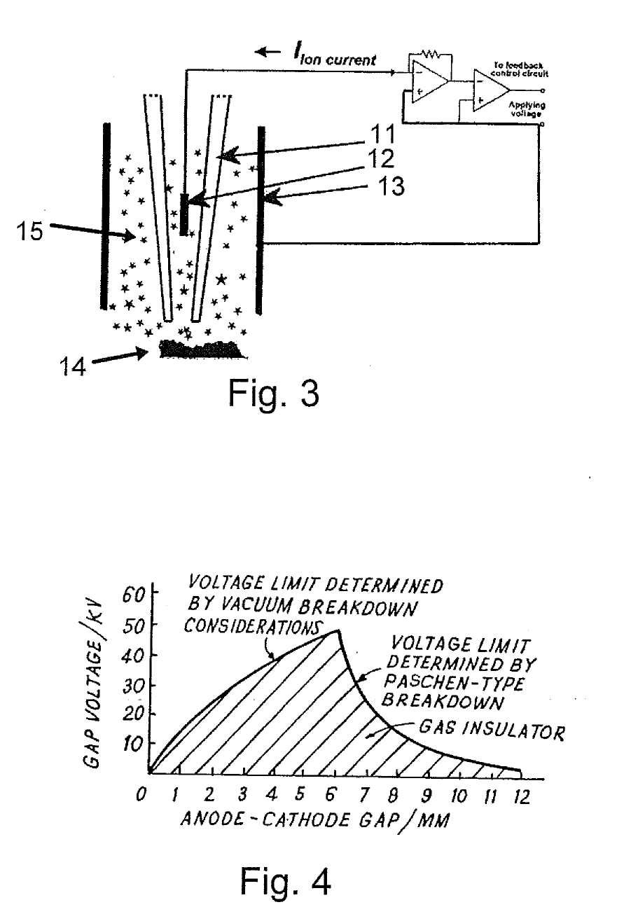

As a further alternative to using an ion source, suitable ionic flow may be achieved at low pressures through the application of an appropriate electrode potential. This alternative arrangement is shown in FIG. 3 where like reference numerals have been used as for the FIG. 2 arrangement. At low pressures, the impedance between the electrodes is governed by Paschens Law (see FIG. 4), and, for any voltage applied between the electrodes, there is a range of pressures at which conduction will take place between the electrodes, and not between them and any conductor situated at a distance less than that between the electrodes.

### Applications

There are a huge range of applications for which imaging using the principles of the microscopy arrangement described above is well suited.

The metallurgical examination of specimens both in and as a source of high radiation fields is difficult because of the darkening of optical components caused by the field, where traditional optical microscopy techniques are used. The apparatus described above can allow imaging of etched specimens where the surface structures have dimensions in the nm region. This would allow such examinations of, e.g. fuel element cladding and other highly radioactive structures. The electronic components could be positioned remotely from the nano-pipette head unit to protect them from radiation damage.

Any nano-structured surface, e.g., semiconductors, MEMS, NEMS, microfluidics and micro-engineering components and electronics can be imaged using the apparatus and method described.

Where a UV lamp is used as the source of ionising radiation, the examination of dry structures becomes possible, with subsequent wetting and re-examination by conventional SICM, thus providing complementary information from the two techniques.

Using single and multi-barrelled pipettes would allow delivery of active gases and fluids to specific locations determined by prior scanning using the same pipette and the effects on the surface topography can be further determined by subsequent imaging.

In the case of, for example, wafer activation in semiconductors, the activation state of, e.g. a silicon wafer, could be investigated using the apparatus and method described herein by monitoring the ion current behaviour. This could show differential patterns with, e.g. chemical vs. plasma activation. The ability to image a silicon wafer alone at high resolution without making contact with the surface confers a significant advantage over other frequently used present techniques.

The method and microscopy apparatus described herein have the capability to be combined with a number of hybrid techniques including, but not limited to, optical methods, confocal and fluorescence by assembling the microscopy apparatus on an optically inverted microscope; surface plasmon resonance (SPR) through delivery of surface plasmon waves from above or below the sample; Raman and other laser spectroscopies; and scanning near-field optical microscopy (SNOM). Utilisation of the hollow nano-pipette for delivery of light to the surface can be achieved for particular applications.

Mechanical manipulation and force measurements may be achieved using positive and negative gas flow through the pipette. The tip-sample feedback operates in such a way that the pipette tip does not make contact with the surface, including loose particles. Therefore, by application of gas pressure to loose particles, these can be drawn up or displaced from their original locations through this pneumatic pressure applied from the pipette aperture. For example, manipulation of carbon-nanotubes (CNTs) to bridge circuitry gaps can be performed. Force measurements may be implemented by virtue of the effect of pneumatic pressure variation on surface features using the pipette in feedback mode to monitor surface height changes upon the application of calibrated pressure.

It will, of course, be appreciated that the microscopy method and apparatus described herein is not limited to the specific features described. Differences and alternatives are envisaged without departing from the scope of the invention as defined in the accompanying claims.

1. A scanning probe microscope for interrogating a surface, comprising a first electrode located within the scanning probe; a second electrode located adjacent the probe and the surface; and means for ionising the environment in the vicinity of the electrodes such that an ion current flows upon application of a potential difference across the electrodes.

2. A scanning probe microscope according to claim 1, wherein the probe is a hollow micro- or nano-pipette.

3. A scanning probe microscope according to claim 1, wherein the means for ionising the environment in the vicinity of the electrodes comprises a radiation source.

4. A scanning probe microscope according to claim 3, wherein the radiation source is an ultraviolet lamp, an alpha or beta source, or an object having the surface under interrogation.

5. A scanning probe microscope according to claim 1, wherein the environment in the vicinity of the electrodes includes an insulating fluid excluding liquids, or a vacuum.

6. A scanning probe microscope according to claim 1, further comprising control means for controlling the position of the probe relative to the surface.

7. A scanning probe microscope according to claim 6, wherein the control means is adapted to maintain a tip of the probe at a fixed distance from the surface during a raster scan.

8. A scanning probe microscope according to claim 6, wherein the control means is adapted to maintain a tip of the probe at a fixed distance from the surface during a raster scan and the control means is adapted to maintain a tip of the probe at a fixed distance from the surface based upon a signal representative of the ion current flow.

9. A scanning probe microscope according to claim 1, wherein the probe is adapted to be oscillated axially, orthogonal to the surface.

10. A method for interrogating a surface using a scanning probe microscope having a first electrode located within the scanning probe and a second electrode located adjacent the probe and the surface, the method comprising moving the scanning probe into close proximity with the surface; ionising the environment in the vicinity of the electrodes, and applying a potential difference across the electrodes to generate an ion current flow in the ionised environment between the first and second electrodes.

11. A method according to claim 10, wherein the step of ionising the environment comprises exposing the environment to ionising radiation.

12. A method according to claim 10, wherein the step of ionising the environment comprises generating a vacuum around the electrodes and selecting a potential difference across the electrodes sufficient to induce ionic flow.

13. A method according to claim 10, further comprising maintaining a tip of the probe at a fixed distance from the surface during a raster scan based upon a signal representative of the ion current flow.

14. A method according to claim 13, further comprising driving the probe in axial oscillation orthogonal to the surface.

15. A method according to claim 13, further comprising generating a topographical image of the surface.
